(19) United States
(12) Patent Application Publication
(10) Pub. No.: US 2004/0215580 A1
(43) Pub. Date: Oct. 28, 2004

(54) Discounted printing

(76) Inventors: Maurizio Pilu, Bristol (GB); Andrew Arthur Hunter, Bristol (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/345,392

(22) Filed: Jan. 16, 2003

(30) Foreign Application Priority Data
Jan. 10, 2002 (GB) 0200894.4

(51) Int. Cl. G06G 7/00

(52) U.S. Cl. 705/400

(57) ABSTRACT

A discount service for consumer printing of digital images stored using an authorised device recognizes identification data originating from the authorised device, to identify at least one digital image stored using the device

### FIELD OF INVENTION

The present invention relates generally to discounted printing. More particularly, but not exclusively, the invention relates to a system for providing a discount service for consumer printing, and to a method of providing a discount service for consumer printing.

### DESCRIPTION OF PRIOR ART

International Patent Application Publication Number WO-A1-01/02948 discloses allowing a printer's or a user's account to accumulate a credit balance and for all or a portion of this balance to be presented to the corresponding user or users as a collection of points. If the printer account has a credit balance, then the corresponding points may be redeemed by the user or users for particular products or services.

International Patent Application Publication Number WO-A1-01/02946 discloses a printer module having an account that contains data indicative of the usage of the printer. The account is debited with amortized capital costs and running costs of the printer and credited with fees earned via the printer. Any credit balance can be redeemed.

International Patent Application Publication Number WO-A1-0076204, assigned to Hewlett-Packard Company, discloses a document delivery system for automatically printing a document on a printing device. When a print schedule indicates that a document should be printed, the document is automatically transmitted to the printing device. A user profile is stored that contains information about a recipient of the document. The user profile can be used to select advertising to be included in the document. A product can be subsidized for a user, based on the information contained in the user profile. For, example, if a user profile indicates that a user has printed a number of preferred documents, a product such as an ink consumable can be sent to the user.

U.S. Pat. No. 5,477,264 discloses a digital electronic camera for capturing and storing images in a removable storage device, which is also preloaded with enhancement files for effecting operation of the system. The camera is controlled by a programmable processor which is capable of receiving the enhancement files. The files contain software for updating the operating code of the camera, for modifying captured images in selected ways, for modifying the camera in special situations, or for communicating non-captured image-like data to the camera.

None of the prior art noted above facilitates associating use of a removable storage medium or image capture device with a discount for consumer printing.

### SUMMARY OF THE INVENTION

In accordance with one aspect of the invention, there is provided a system for providing a discount service for consumer printing of digital images stored using an authorised device, the system comprising recognition apparatus operable to recognise identification data originating from the authorised device, so as to identify at least one digital image stored using the device.

In accordance with a further aspect of the invention, there is provided a method of providing a discount service for consumer printing of digital images, comprising using identification data originating from a device that is authorised by a provider of the device for enabling discounted consumer printing, so as to identify at least one digital image stored using the device.

In accordance with a still further aspect of the invention, a method of discounting printing consumables is performed with the aid of a removable storage medium or image capture device operable to enable discounted printing by a consumer of digital images stored or captured thereon, and comprises:

a) identifying printing by the consumer of at least one of said digital images; and

b) providing a printing consumable to the consumer at a discount.

In accordance with a still further aspect of the invention, there is provided a method wherein a discounted consumer printing service provider provides a discount printing service for consumers of digital images stored using an authorised device, the service including the provision of information enabling a printing consumables provider to provide to respective said consumers printing consumables at a discount related to an estimated cost of printing by the respective consumers, for thereby encouraging the consumers to print the digital images.

In accordance with a still further aspect of the invention, there is provided a method wherein a printing consumables provider provides for a provider of removable storage devices and/or image capture devices a discount printing service in which the printing consumables provider provides printing consumables to consumers thereof at a discount related to estimated costs of printing by the respective consumers of digital images stored using respective said devices, whereby the consumers are encouraged to print the digital images.

Preferably, the printing consumables are provided to the consumer at a discount substantially proportional to, and less than or substantially equal to, the estimated printing costs. This facilitates overcoming of a potential problem whereby consumers would otherwise be encouraged to print merely to obtain unrelated, and possibly excessive, benefits in connection with the printing.

In accordance with a still further aspect of the invention, there is provided a capture device or removable storage device for use in storing digital images, operable to provide identification data for use in a system or a method as described above.

In accordance with a still further aspect of the invention, an image capture device for storing captured images on removable storage is operable to generate tamper-resistant identifying information for storing on the removable storage as an integral part of the or each stored image, for use in a system as described above.

In accordance with a still further aspect of the invention, an image capture device for use with removable storage is operable to process and store respective data signatures of digital images captured thereby, for use in a system or a method as described above, for identifying digital images captured and stored using the device.

In accordance with a still further aspect of the invention, there is provided printing apparatus operable to detect identification data originating from an authorised device, for use in a system or a method as described above.

In accordance with a still further aspect of the invention, a means for discounting printing by a consumer of digital images comprises means for using identification data, originating from a device that is authorised by a provider of the device for enabling discounted consumer printing, so as to identify at least one digital image stored using the device.

In accordance with a still further aspect of the invention, a method performed with the aid of a removable storage device in association with a discounted consumer printing service enables a consumer to obtain a discount for printing digital images which are captured by an image capture device onto the storage device.

In accordance with a still further aspect of the invention, a method performed with the aid of an image capture device in association with a discounted consumer printing service enables a consumer to obtain a discount for printing digital images which are captured by the image capture device onto storage apparatus connected with the device.

The invention, in at least one of its aspects, facilitates associating use of a removable storage medium or image capture device with a discounted consumer printing service, for stimulating consumer interest in the medium or device, and/or encouraging consumer printing of images, and/or encouraging sourcing of printing consumables from a provider of the discounted printing consumables.

Thus, a printing consumables provider can benefit because of a tendency to increase consumer printing volume and increase the requirement for printing consumables, and because a printing related discount is likely to attract consumers to that provider. A discounted printing service may be effected directly by a printing consumables provider or, alternatively, an independent discounted printing services provider can benefit by charging, for example a provider of an image capture device or removable storage device, for the service.

### BRIEF DESCRIPTION OF THE DRAWINGS

In order that the invention may be well understood, various embodiments thereof will now be described, by way of example only, with reference to the accompanying drawings, in which:

FIG. 1 is a schematic diagram illustrating parties to a system for providing a discount to a consumer for printing digital images stored using an authorised device, and one possible means of interconnecting the parties across a network;

FIG. 2 is a schematic diagram illustrating a method of providing the discount using an authorised removable storage device;

FIG. 3 is a schematic diagram illustrating a method of providing the discount using an authorised image capture device; and

FIG. 4 is a schematic diagram illustrating use of the authorised image capture device with rewritable storage.

### DETAILED DESCRIPTION OF THE EMBODIMENTS

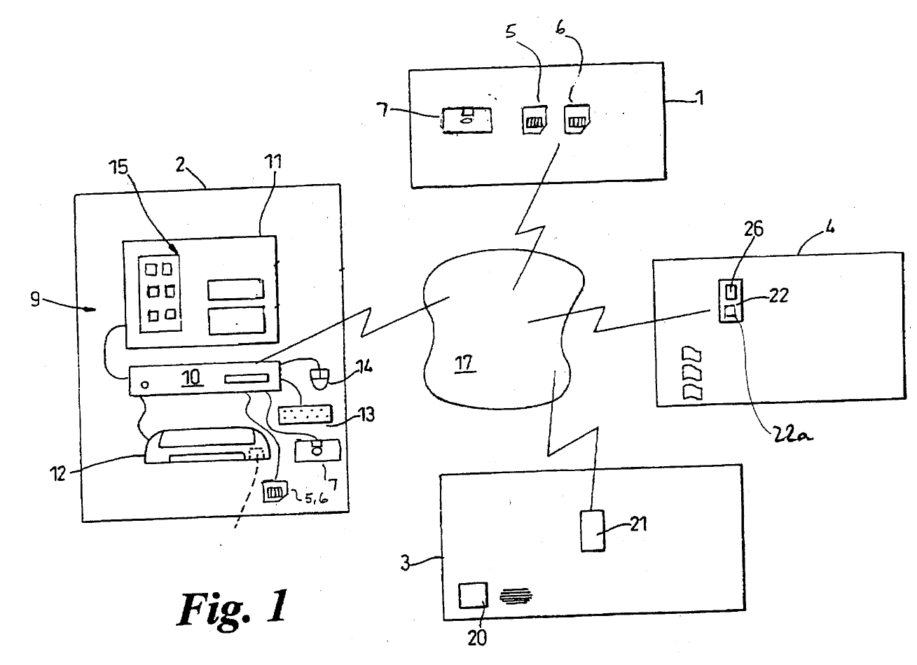

FIG. 1 shows schematically four parties 1 to 4. Party 1 is a provider of devices for use in storing digital images, at least some of which are operable to provide identification data for use in a discount service for consumer printing as described below. The device provider 1 is, for example, a manufacturer and/or seller of devices.

Party 2 is a consumer having an interest in using a device, provided by the device provider 1, for printing images digitally captured and/or stored using the device. The consumer 2 is generally a private consumer who wishes to print material locally on a home printing apparatus 9, whereby the consumer 2 is responsible for costs associated with the printing process. However, the embodiments may also be relevant to business consumers for printing on business premises.

Party 3 is a provider of printing consumables, for example a manufacturer and/or seller of at least one type of printing consumable. Party 4 is a discounted consumer printing service provider 4 which provides a discounted consumer printing service for enabling the other parties 1, 2, 3 to implement various aspects of a discounted printing process described in further detail below. The discounted consumer printing service provider 4 is shown as a separate entity, but the functions of the discounted consumer printing service provider 4 may alternatively be carried out by the printing consumables provider 3.

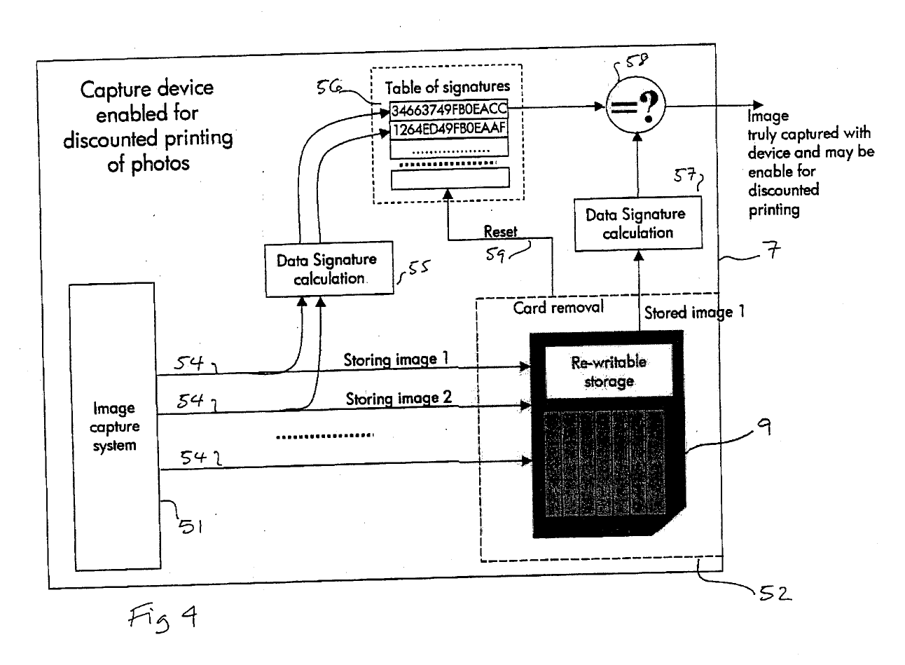

The devices provided by the device provider 1 are, for example, a removable storage device such as a write-once removable storage device 5 or a rewritable removable storage device 6, and/or an image capture device such as an electronic digital camera 7. The term removable in this connection implies that the storage device 5, 6 is insertable into and removable from an image capture device, which may be of known type, during normal consumer use. The storage devices 5, 6 of the embodiment are memory cards. The image capture device 7 is adapted to store images captured thereby to storage apparatus which may be of known type. For example, the storage apparatus can take the form of a rewritable memory card 9 (FIG. 4) insertable into and removable from the camera 7, rewritable storage apparatus 8 non-removable from the camera 7 during normal consumer use, and/or a remote storage device such as a PC or a remote storage server.

The devices 5, 6, 7 are operable to provide identification data recognisable by a discounted consumer printing system described in further detail below, to enable the system to recognise an authorised device. The identification data can be directly provided to the system from an authorised device or embedded by an authorised device in image data stored using an authorised device, as will be described in further detail below in connection with the various embodiments. The identification data is used for ensuring that consumer printing is discounted only for images which have been captured by and/or stored on a device 5, 6, or 7 which has been authorised by the device provider 1 for use in discounted printing.

The consumer 2 possesses printing apparatus 9 connectable for communication with at least one of the devices 5, 6, and 7. The printing apparatus shown in FIG. 1 comprises computer apparatus in the form of a personal computer (PC) 10, display means in the form of a monitor having a display screen 11, a printer device 12, and command input apparatus in the form of a keyboard 13 and mouse 14, for inputting user commands to the PC 10. The PC 10 is connectable to a communications network such as the internet 17 for communication with the other parties 1, 3, 4. The

Many alternative forms of printing apparatus will be apparent to one of ordinary skill. For example, the printing apparatus can alternatively comprise a printer device having computer processing capability and hardware, firmware and/or software adapted to provide printing capability from one of the devices 5, 6, 7 directly, or indirectly via remote storage. Alternatively, the camera device 7 or another camera device possessed by the consumer can be adapted to print images directly therefrom.

The printing consumables provider 3 takes orders from the consumer 2 when required, for supplying at least one type of printing consumable 20, for example ink cartridges for ink jet printers, toner cartridges for laser printers, ink or toner for refilling such cartridges, paper or other sheet-like printable media or any other product or substance which is depleted during printing activity. The printing consumables provider 3 is shown as being equipped for electronic commerce (e-commerce), having for this purpose a computerised ordering system including computing apparatus 21 for communicating with consumers 2 over a communication network such as the internet 17. However, it will be apparent to the skilled reader that the printing consumables provider 3 may alternatively or additionally use another method of commerce for providing the printing consumables.

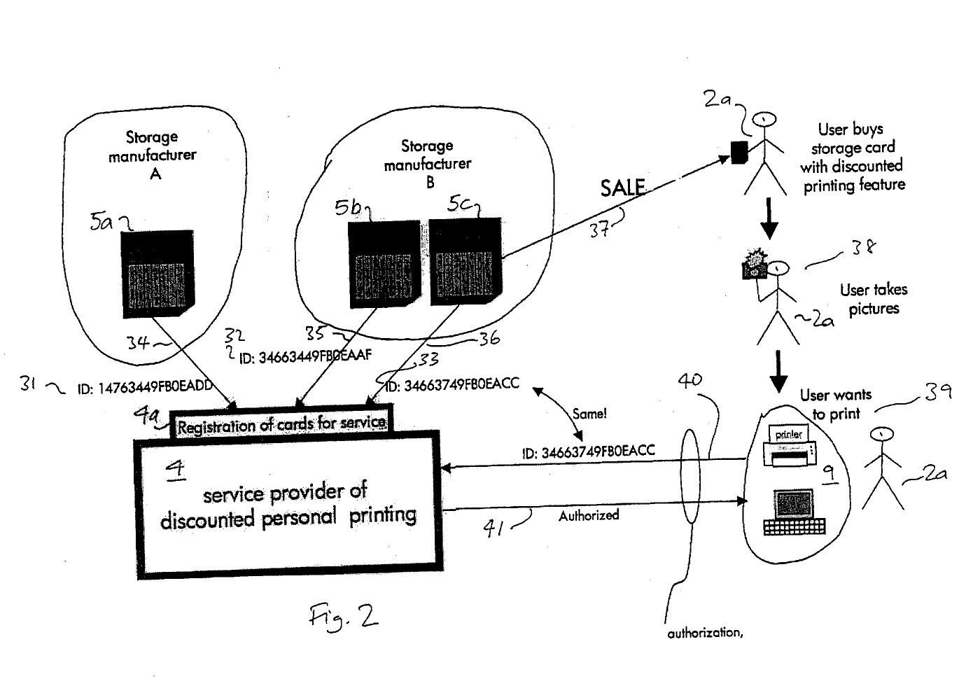

Referring now to FIG. 2, in a first embodiment removable storage devices in the form of write-once memory cards 5a, 5b, 5c, authorised by respective card providers A, B for use in securely enabling discounted consumer printing, have identification data respectively stored thereon in a tamper-resistant fashion during manufacture. The identification data represent respective alphanumeric identification signs 31, 32, 33. The identification signs 31-33 are registered (steps 34, 35, 36) with a registration service 4a of the discount service provider 4 by the device providers A, B.

The discounted consumer printing service provider 4 manages a system including computer apparatus 22 arranged to communicate with the other parties over a communication network, for example the internet 17. The computer apparatus 22 comprises recognition apparatus in so far as it is programmed to recognise the identification data originating from an authorised device 5, 6, 7 for facilitating discounted printing by the consumer 2 of digital images stored using the authorised device 5, 6, 7. For this reason, the computer apparatus 22 includes a look-up table 22a for receiving identification data relating to the identification signs 31, 32, 33 of devices 5, 6, 7 which have been registered.

The computer apparatus 22 can take any convenient form, and may comprise separate and/or geographically distributed interconnected devices. Information for enabling the computer apparatus 22 to recognise authentic identification data is obtained from the device provider 1 as described below.

Registration is effected at an appropriate time, for example immediately after manufacture or after sale of a card 5a-c to a consumer, preferably over the communication network 17. Whilst FIG. 2 shows registration and sale effected by a card manufacturer 5c, the term “provider” should be understood to include, for example, a device manufacturer, a device seller or a combination of both, and registration can be effected by either party by agreement with the discounted printing service provider 4. The registered identification signs 31-33 are stored in the look-up table 22a in the computer apparatus 22 of the discount printing service provider 4.

FIG. 2 illustrates a sale (step 37) of an authorised write-once memory card 5c to a consumer 2a of memory cards and printing consumables. The device provider 1, by prior agreement with the discounted consumer printing service provider 4, is able to associate sale of the card 5c with a discount for consumer printing of images captured by an image capture device and stored on the card 5c. The discount offered is a proportion of the estimated cost to the consumer 2a of consumer printing of the stored images, and may be the full estimated cost. The discount enhances the value proposition of the memory card 5c. “Consumer printing” in this context includes printing using personal printing apparatus, for example the printing apparatus 9, as juxtaposed to a commercial printing service, and may also include printing on business premises for use of the printed output by the consumer for the purposes of that business.

In return for using the consumer printing service, the card provider 1 agrees to pay the discount printing service provider 4 a predetermined amount, or a percentage of the cost, for each card 5c sold. The service provider 4 benefits further because the discount is only realisable through the printing consumables provider 3 associated with the service provider 4. Of course, the card provider 1, consumables provider 3 and discount printing service provider 4 can be the same entity or affiliated entities, in which case the value of the discount given to the consumer 2a is compensated for by increased sales of cards and increased demand for printing consumables.

When the consumer 2a using the memory card 5c in a known type of camera takes a picture (step 38), thereby capturing an image, data relating to the time of capture and storage is stored at the same time as the image data. Alternatively or additionally, on the occurrence of registration of the card 5c with the registration service 4c or the purchase (step 37) of the card 5c from the provider B, data may be stored on the card 5c by the service 4a or the provider B securely recording the time and nature of the event. In order to realise the discount for printing, the consumer 2a may be required to print the image within a predetermined time period following the capture or other type of event.

When the consumer wishes to print the image (step 39) the memory card is connected to the printing apparatus 9 in known manner, for example by connecting a capture device with the card inserted therein to the printer device 12, directly or via the PC 10, or alternatively connecting the card 5c to the printer 12 or PC 10 directly.

To obtain authorisation for discounted printing, the printing apparatus 9 communicates via the network 17 with the computer apparatus 22 to query whether the identification sign 33 on the card 5c appears in the look-up table of registered identification signs (step 40). The computer apparatus 22 can also use the data relating to the time of storage to verify whether the predetermined permitted time period has elapsed within which a discount will be offered for printing a particular stored image. Furthermore, before authorising a discount the computer apparatus accesses from the printing apparatus 9 information relating, for example, to the type of printer device 12 and its printer cartridge type.

Clearly, for efficient operation of the discount printing service the authorised device should be securely associated with the images which are to be printed at a discount, so that users of the system can be confident that identification data originating from unauthorised sources cannot be impermissibly recognised as identification data originating from an authorised device. In the presently described first embodiment, one way of facilitating such security of association is to ensure that the card 5c is connected for interrogation thereof by the computer apparatus 22 prior to authorisation of a discount and also that the identification data stored on the card 5c is resistant to tampering and thus cannot easily be altered on the card 5c or replicated on another card. Many appropriate methods for securing the identification data will be apparent to the skilled reader.

To make use of the discounted printing service, the consumer 2a and/or the printer device 12 is registered with the discount service provider 4. Consumer registration can be effected at any convenient time. For example, the consumer 2a may register for the service in response to advertisements and be provided with information directing him to a seller of authorised devices, the card provider B may register the consumer's details at point of sale, or registration may be effected immediately prior to the first authorised printing event. Consequently, the discounted printing service provider 4 opens an account 26 in respect of the consumer 2a and/or printer device 12.

The account 26 may be stored on the computer apparatus 22 and/or the printing apparatus 9, or may be part stored on each of the computer apparatus 22 and the printing apparatus 9. The account 26 comprises, for example a computer program implemented in firmware, software and/or hardware.

A processing module 9a is provided for collecting and processing data for, and communicating with, the account 26. For example, cost, account status and authorisation data can be received from the computer apparatus 22, authorised device identification data, and print event data including printer consumption and the serial numbers of printer devices and printer cartridges may be gathered from the printing apparatus 9, and data relating to discounts provided can be received from the computing apparatus 21. The module 9a is conveniently part of the printing apparatus 9, and in the first embodiment is provided in the printer device 12. Alternatively, the module could be stand alone or provided in the PC 10. The module 9a can be implemented in firmware, software and/or hardware.

The service provider 4 may authorise discounted printing only if module 9a at the time of printing sends to the computer apparatus 22 a signal confirming use of a printer and/or printer cartridge of predetermined type. This encourages use of equipment authorised by the service provider 4, which may for example be restricted to equipment provided by the printing consumables provider 3.

When discounted printing is authorised, the computer apparatus 22 sends a signal for receipt by the printing apparatus 9 authorising discounted printing (step 41). If communication with the computer apparatus 22 is not maintained during printing, the printing apparatus can store details of the printing in the module 9a, for automatically updating the account 26 with the discounted amount when communication is re-established. In the present embodiment, the signal is passed to the module 9a which causes the printer device 12 to print the or each image automatically. Alternatively, the module 9a enables printing on a further user command.

When printing is complete, the printing outcome is reported by the printing apparatus 9 to the service provider 4. The report confirms the images actually printed and furthermore contains data collected by the module 9a for use in estimating the actual costs of the printing event to the consumer 2. The collected data includes, for example, the amount and type of ink and the quantity and type of printable media, such as paper and overhead transparencies, used in the printing, and usage details of any other printing consumable as required. The collected data further includes at least one of: the type of printer and print cartridge used and a unique identifier for the printer 12. The account module 9a is used to automatically store data relevant to authorisation and estimation purposes, and to communicate this data to the computer apparatus 22 when communication is established. Account data can be held in the module 9a for presenting account information to the consumer 2a offline.

The data from the report is received, processed and stored in an account 26 by the computer apparatus 22. Alternatively, the data is at least partially processed by the module 9a and/or the PC 10 before sending to the computer apparatus 22. The processing results in an estimation of the actual costs incurred by the consumer 2a for locally printing the discounted images. The precise method of calculation can be varied as desired. Printer amortisation costs are optionally included ie the printer 12 is treated as a consumable for the purposes of the estimation. Estimated costs of printing events are stored in the account 26. Following printing 39, the consumer 2a may be automatically informed of the estimated printing costs and the discounted amount, and also of the cumulative total discount stored against his account and not redeemed.

The discount can be calculated by the computer apparatus 22 at different discount rates, depending on a number of times that a particular image has been printed by the consumer. This is particularly convenient to achieve when unique identification data is embedded in each image, as described in further detail below.

Following the printing event, a charge for the discounted amount is automatically raised over network 17 with the manufacturer or other device provider 1 and the device provider 1 is billed in an automated fashion for the discount. Alternatively, where an upfront amount is paid to the discounted printing service provider 4 for each card sale and/or where the discounted printing service provider 4 and printing consumables provider 3 are integral or affiliates, no further charge may be necessary. In this connection, by virtue of the discounted printing service, additional demand can be generated for printing consumables to be supplied by the printing consumables provider 3.

Billing the device provider 1 automatically and immediately after printing is not essential, and many other ways and times of settling the charge from the service provider 4 to the device provider 1 will be apparent to one of ordinary skill. For example, the device provider 1 may be billed only after a consumer 2a is provided with discounted printing consumables.

When the consumer 2a identifies a need for replacement printing consumables 20, for example an ink cartridge, he will have an incentive to direct his purchase request to the printing consumables provider 3 who is offering a discount via the discounted printing service 4, thus providing additional business to the consumables provider 3 and differentiating the consumables provider's services from those of its competitors. In one aspect of the embodiment, such requests are only possible over e-commerce channels, although in other aspects other sales and distribution channels can also be provided.

When the consumer orders the replacement ink cartridge or other printing consumable from the consumables provider 3, the computing apparatus 21 of the consumables provider 3 interrogates the computer apparatus 22 of the discount printing service 4 to determine a total discount value presently credited to an account associated with the consumer 2a and/or the printing apparatus 9 of the consumer 2a. The printing consumables provider 3 is then able to confirm the order and the discount.

Alternative methods of effecting authorisation of discounted printing and of realising the discount will be apparent to the skilled man. Some further examples are described in copending U.S. patent application Ser. No. 10/272,978 filed on Oct. 10, 2002, Lowe Hauptman Gilman & Berner docket number 1509-360, Hewlett-Packard docket number 30019663-2 US.

It is advantageous that the printing consumables provider 3 itself provides and manages the discount printing service, thereby obviating the requirement to deal with the third party service provider 4.

Because discounts are realisable in proportion to the costs incurred and only against printing consumables, spurious print of images which may otherwise be of little interest to the consumer, merely to obtain some sort of credit or reward, is discouraged.

In a modification of the first embodiment, the authorised devices 5a-c are rewritable removable storage devices in the form of memory cards.

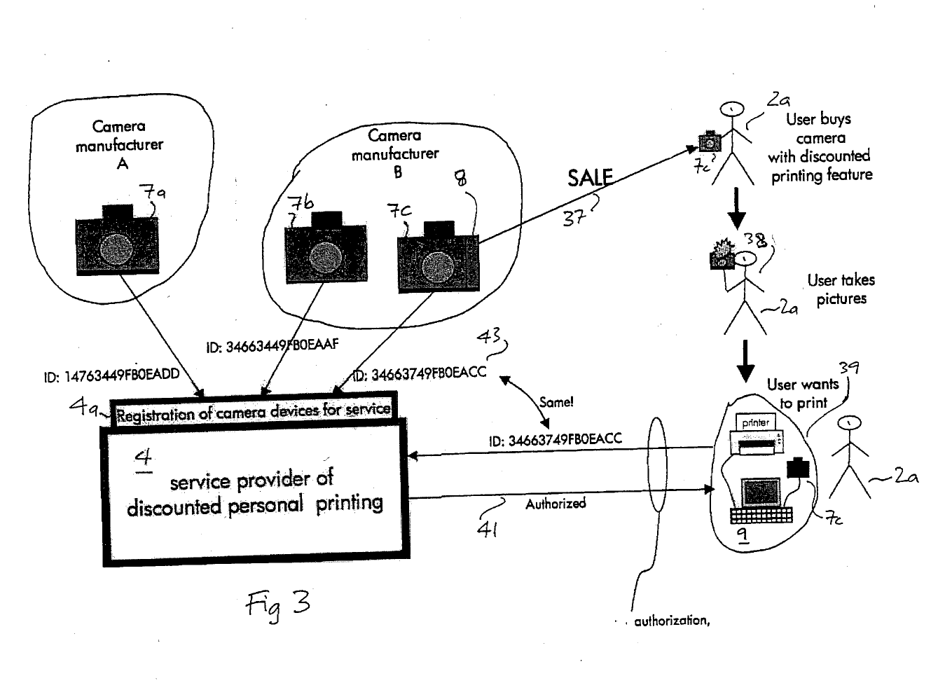

Referring now to FIG. 3, a further modified embodiment is illustrated. The further embodiment is analogous is many respects to the first embodiment described above, and for economy similar reference signs are used for analogous items and only differences between the embodiments are described in detail below. The authorised devices according to this further embodiment are image capture devices in the form of electronic digital cameras 7a, 7b, 7c having storage apparatus 8a integral therewith which in non-removable under normal conditions of consumer use. When a camera 7c is sold to a consumer 2a (step 37) the camera's identification sign 43 is registered with the registration service 4, and the consumer 2a and/or the printing apparatus 9 is registered with the discounted printing service 4.

For securely associating an authorised camera 7c with images captured by the consumer 2a and stored on the camera (step 38) and which are to be printed (step 39) at a discount, tamper-resistant identifying data relating to the reference sign 43 is stored by the manufacturer B on the camera 7c. Also, prior to authorisation (step 41) of discounted printing the camera 7c is connected for interrogation thereof by the computer apparatus 22 to enable the computer apparatus to confirm that the camera is a registered authorised device. For this purpose, the camera can be connected in any convenient manner to the printing apparatus 9, for example the camera can connect directly to the PC 10 or printer device 12, or directly with computer apparatus 22 where printing is possible directly by the camera 7c. For additional security, the camera 7c remains connected during discounted printing. Disconnection during printing may result in the discount being disallowed.

In a still further modified embodiment the camera 7a-c is for use with remote or removable (rewritable or write-once) storage apparatus and is adapted to store identification data in tamper-resistant form in image data when images are captured by and stored using the camera 7a-c. The identification data is, for example, generated by the camera 7a-c in the form of a steganographic mark such as a watermark, and/or of metadata. The identification data can be fixed for all images captured by the device, specifically generated for each captured image, or part fixed and part specific. In this manner, it is not necessary to connect the camera device 7a-c to the computer apparatus 22 in order to securely associate the camera 7a-c with images captured by the consumer 2a and stored on the camera (step 38) and which are to be printed (step 39) by the consumer at a discount.

When it is desired to use a camera 7a-c according to the still further modified embodiment with removable rewritable storage apparatus, the arrangement shown in FIG. 4 can be employed for additional surety of recognition of authorised images, i.e. images captured and stored using an authorised camera 7a-c. An image capture device 7 in the form of a camera comprises an image capture system 51, a drive 52 for connecting a rewritable storage apparatus in the form of a memory card 9 to the camera 7, a processor for processing data and internal memory for storing data. When the consumer 2a takes pictures with the camera 7, each image is stored (step 54) in the rewritable storage apparatus 9. The camera calculates (step 55) a unique data signature for each image stored. The signatures are stored in a table (step 56) in internal memory.

When authorisation (step 41, FIG. 3) is requested for discounted printing of an image stored on the rewritable card 9, a further data signature calculation (step 57) is performed, and the results of the further calculation are compared (step 58) with the signatures stored in the table 56. If a match is found, discounted printing is authorised.

Writing of signatures to the table (step 56) is permitted only for images captured by the camera 7, and this camera is rendered tamper-resistant in this respect. To provide further surety against impermissible authorisation of discounted printing for images which have been loaded onto the card 9 from other sources, the contents of the signatures table are erased (step 59) each time the card is removed from the camera 9. Calculation step 57 and comparison step 58 are carried out by the camera 7 in FIG. 4; however, these steps can alternatively be performed by another device. For example, the steps 57 and 58 can be performed by the computer apparatus 22 of the discounted printing service provider 4. The data signature calculation described with reference to FIG. 4 can also be used to provide additional security for capture devices having non-removable storage.

It will be apparent that the above-described embodiments provide a simple mechanism for enabling a storage device to provide discounted printing of, for example, photographic images stored digitally therein. Using certain aspects of the embodiments, a manufacturer of, say, a write-once storage card is able to offer a discount, say 30%, on printing on personal printers of images stored using the authorised card. A printing consumables company implementing the discount service could arrange for an upfront service from the manufacturer, say $0.5 per card, and can also benefit from any increased printing demand, the discount being made available only for printing using specified equipment associated with the discount service implementer. The printing consumables company could itself manufacture and sell authorised cards.

According to certain other aspects of the above-described embodiments, the printing consumables company could also offer the discount service to camera providers, providing a differentiating feature in that consumers buying the camera from that provider are offered a discount, say 20%, on consumer printing of pictures captured using the camera for a limited or unlimited period following sale. The discount service provider benefits from an upfront payment on the camera, say $5 per camera, and can also benefit from any increased printing demand, the discount being made available only for printing using specified equipment associated with the discount service provider. The printing consumables company could itself manufacture and/or sell authorised cameras.

It will be apparent from the above that in at least some aspects the embodiments facilitate association of a removable storage medium with a personal discounted printing service which enables and/or authorises discounted printing of image data stored on the medium, and that in at least some aspects the embodiments facilitate associating an image capture device with a personal discounted printing service to enable and authorise discounted printing of image data stored by the capture device either on fixed, removable or remote storage.

The embodiments described above facilitate discounted, including effectively free, printing by a consumer at a time and location which is convenient to him. The consumer sees a direct correlation between a discount and an amount of discounted content printed on an authorised printer. A device provider 1 can distinguish itself from or compete more effectively with competitors, for example by offering a device in association with discounted printing.

1. A system for providing a discount service for consumer printing of digital images stored using an authorised device, the system comprising recognition apparatus operable to recognise identification data originating from the authorised device, so as to identify at least one digital image stored using the device.

2. A system as claimed in claim 1, wherein the authorised device includes a removable storage device for storing thereon digital images captured by camera apparatus.

3. A system as claimed in claim 2, wherein the authorised device includes a write-once device.

4. A system as claimed in claim 1, wherein the authorised device includes an image capture device operable to direct captured images, in digital form, into storage apparatus.

5. A system as claimed in claim 4, wherein the storage apparatus is non-removable from the image capture device during normal consumer use.

6. A system as claimed in claim 1, wherein the identification data is adapted to be stored on the authorised device in a tamper-resistant form.

7. A system as claimed in claim 1, further comprising registration apparatus operable to provide a look-up table including identification data of authorised devices which have been registered with the system, for secure identification of printing from registered authorised devices.

8. A system as claimed in claim 4, wherein the storage apparatus is removable from the image capture device or remote from the image capture device.

9. A system as claimed in claim 8, wherein the image capture device is operable to compile a table of signatures corresponding to the or each image captured and stored using the image capture device, for secure identification by the image capture device of images captured and stored using the image capture device.

10. A system as claimed in claim 2, wherein the identification data is adapted to be stored in a tamper resistant manner in image data representing the or each stored image.

11. A system as claimed in claim 10, wherein the identification data comprises a steganographic mark or metadata, generated by the authorised device.

12. A system as claimed in claim 1, operable to enable discounting when the authorised device is connected for interrogation thereof by the system.

13. A system as claimed in claim 1, operable to access information relating to an occurrence of an event, and to enable discounting in response to the or each digital image being printed within a predetermined time period after the event.

14. A system as claimed in claim 13, wherein the event is any one selected from the following: a capture event; a storage event; a registration of the authorised device with the system; and a purchase of the authorised device.

15. A system as claimed in claim 1, operable to enable discounting at a first predetermined rate for initial consumer printing of the or each digital image, and to enable discounting for further consumer printing of the or each digital image at at least one further predetermined rate, the or each further rate varying from the first rate.

16. A system as claimed in claim 1, comprising estimating apparatus operable to estimate costs incurred by a consumer for printing the or each identified digital image.

17. A system as claimed in claim 16, operable to store the estimated costs automatically and electronically in an account associated with at least one of (a) a consumer and (b) at least one printing apparatus of the consumer.

18. A system as claimed in claim 16, adapted to base the estimated costs at least partly on information accessed from a printing apparatus of the consumer.

19. A system as claimed in claim 16, adapted to automatically inform a consumer of an estimated value of the printing costs incurred by the consumer for printing at least one of (a) the or each digital image and (b) of an amount of discount allowed.

20. A system as claimed in claim 1, adapted to gather data, prior to authorising discounted consumer printing, about a printing apparatus presently connected for printing the or each digital image and/or an ink cartridge used in the printing apparatus.

21. A system as claimed in claim 1, operable to provide information to a printing consumables provider regarding a total discount value presently credited to an account associated with the consumer and/or a printing apparatus of the consumer.

22. A system as claimed in claim 1, operable to bill a device provider, so as to pass on to the device provider at least some costs associated with the consumer printing of the or each image.

23. A method of providing a discount service for consumer printing of digital images, comprising using identification data originating from a device that is authorised by a provider of the device for enabling discounted consumer printing, so as to identify at least one digital image stored using the device.

24. A method as claimed in claim 23, wherein the authorised device includes a write-once removable storage device for storing thereon digital images captured by camera apparatus.

25. A method as claimed in claim 23, wherein the authorised device includes an image capture device operable to direct captured images, in digital form, into storage apparatus.

26. A method as claimed in claim 25, comprising compiling a table of the signatures, for secure identification by the image capture device of images captured and stored using the image capture device.

27. A system as claimed in claim 23, wherein the identification data is stored in a tamper-resistant manner in image data representing the or each stored image.

28. A method as claimed in claim 23, wherein discounting is enabled in response to the authorised device being connected for interrogation thereof.

29. A method as claimed in claim 23, further comprising:
a) requesting the authorised device; and
b) storing identification data of registered authorised devices, for secure identification of printing from registered authorised devices.

30. A method as claimed in claim 23, wherein discounting is enabled when the or each digital image is printed within a predetermined time period after an occurrence of a capture, storage, registration or purchase event.

31. A method as claimed in claim 23, comprising estimating costs incurred by a consumer for printing the or each identified digital image.

32. A method as claimed in claim 31, wherein the estimated costs are stored automatically and electronically in an account associated with at least one of (a) a consumer and (b) at least one printing apparatus of the consumer.

33. A method as claimed in claim 31, wherein the estimated costs are at least partly based on information accessed from a printing apparatus of the consumer.

34. A method as claimed in claim 33, wherein the accessed information relates to at least one selected from the following: an amount of ink used to print the or each digital image; a quantity of paper or similar media used to print the digital image on; and amortisation costs for the printing apparatus.

35. A method as claimed in claim 31, comprising automatically informing a consumer of an estimated value of the printing costs incurred by the consumer for printing at least one of (a) the or each digital image and (b) an amount of discount allowed.

36. A method as claimed in claim 31, comprising providing printing consumables at a discount substantially proportional to the estimated printing costs.

37. A method as claimed in claim 23, wherein the discount is realised in response to a consumer ordering a replacement printing consumable from a printing consumables provider.

38. A method as claimed in claim 23, comprising providing information to a printing consumables provider regarding a total discount value presently credited to an account associated with the consumer and/or a printing apparatus of the consumer.

39. A method as claimed in claim 23, comprising gathering data, prior to authorising discounted consumer printing, about at least one of (a) a printing apparatus presently connected for printing the or each digital image and (b) an ink cartridge used in the printing apparatus.

40. A method as claimed in claim 23, comprising billing a device provider for the consumer printing of the or each image.

41. A method as claimed in claim 40, wherein the device provider is billed after the consumer is provided with discounted printing consumables.

42. A method as claimed in claim 40, wherein the device provider is billed automatically following estimating of the printing costs.

43. A method as claimed in claim 40, wherein the device provider is a manufacturer of at least one of (a) removable storage devices and (b) image capture devices.

44. A method of discounting printing consumables with the aid of a removable storage medium or image capture device operable to enable discounted printing by a consumer of digital images stored or captured thereon, the method comprising:
a) identifying printing by the consumer of at least one of said digital images; and
b) providing a printing consumable to the consumer at a discount.

45. A method wherein a discounted consumer printing service provider provides a discount printing service for consumers of digital images stored using an authorised device, the service including providing information enabling a printing consumables provider to provide to respective said consumers printing consumables at a discount related to an estimated cost of printing by the respective consumers, for thereby encouraging the consumers to print the digital images.

46. A method wherein a printing consumables provider provides for a provider of at least one of (a) removable storage devices and (b) image capture devices a discount printing service in which the printing consumables provider provides printing consumables to consumers thereof at a discount related to estimated costs of printing by the respective consumers of digital images stored using respective said devices, whereby the consumers are encouraged to print the digital images.

47. A capture device or removable storage device for use in storing digital images, operable to provide identification data for use in a system as claimed in claim 1.

48. A capture device or removable storage device as claimed in claim 47, having tamper-resistant identification data stored thereon for identifying the device.

49. An image capture device for storing captured images on removable storage, the image capture device being operable to generate tamper-resistant identifying information for storing on the removable storage as an integral part of the or each stored image, for use in a system as claimed in claim 1.

50. An image capture device for use with removable storage, the capture device being operable to process and store respective data signatures of digital images captured thereby, for use in a system as claimed in claim 1.

51. An image capture device as claimed in claim 50, adapted to automatically erase data signatures stored by the capture device in response to the removable storage being removed from the capture device.

52. Printing apparatus operable to detect identification data originating from an authorised device, for use in a system as claimed in claim 1.

53. Means for discounting printing by a consumer of digital images, comprising means for using identification data, originating from a device that is authorised by a provider of the device for enabling discounted consumer printing, so as to identify at least one digital image stored using the device.

54. A method performed with the aid of a removable storage device in association with a discounted consumer printing service, the method comprising providing the consumer with a discount for printing digital images which are captured by an image capture device onto the storage device.

55. A method performed with the aid of an image capture device in association with a discounted consumer printing service, the method comprising providing the consumer with a discount for printing digital images which are captured by the image capture device onto storage apparatus connected with the device.

56. A method as claimed in claim 53, wherein the discount is realised by providing the consumer with discounted printing consumables.

57. A method as claimed in claim 54, wherein the discount is substantially proportional to, and less than or substantially equal to, estimated costs to the consumer for the printing of the digital images.

58. A capture device or removable storage device for use in storing digital images, operable to provide identification data for use in a method as claimed in claim 23.

59. A capture device or removable storage device as claimed in claim 58, having tamper-resistant identification data stored thereon for identifying the device.

60. An image capture device for storing captured images on a removable storage, the image capture device being operable to generate tamper-resistant identifying information for storing on the removable storage as an integral part of the or each stored image, for use in a method as claimed in claim 23.

61. An image capture device for use with removable storage, the capture device being operable to process and store respective data signatures of digital images captured thereby, for use in a method as claimed in claim 23, for identifying digital images captured and stored using the device.

62. An image capture device as claimed in claim 61, adapted to automatically erase data signatures stored by the capture device in response to the removable storage being removed from the capture device.

63. Printing apparatus operable to detect identification data originating from an authorised device, for use in a method as claimed in claim 23.
